(19) United States
(12) Patent Application Publication
(10) Pub. No.: US 2006/0019506 A1
(43) Pub. Date: Jan. 26, 2006

(54) Connector for connecting printed boards, and printed board connecting apparatus using the connector

(76) Inventor: Masaaki Harasawa, Yokohama-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/528,653

(22) PCT Filed: Aug. 29, 2003
(86) PCT No.: PCT/JP03/11033

§ 371 Date: Mar. 22, 2005

(30) Foreign Application Priority Data
Sep. 24, 2002 (JP) 2002-277256

(51) Int. Cl. H01R 12/00

(52) U.S. Cl. 439/65

(57) ABSTRACT

A connector for connecting printed boards comprises contact terminals (40a-40x) where contact portions and board connection terminals are connected by spring bodies, a movable housing (20) for receiving the contact portions, and a fixing housing (30) to which the board connection terminals are fixed. Reinforcement pins (50a, 50b) are inserted through through-holes penetrating through the movable and fixing housings. The contact terminals (40a-40x) are installed in the movable and fixing housings, and both housings are connected by the spring bodies with a predetermined spacing between them. Because the reinforcement pins limit the movement direction of the movable housing, vertical shock force applied to the connector housings is smoothly absorbed.

### TECHNICAL FIELD

This invention relates to a connector for connecting printed boards and printed board connecting apparatus using the connector and more specifically relates to a connector for connecting the printed boards and printed board connecting apparatus wherein a crack generation is avoided at the solder connected portion of the printed boards and contact terminals even when a strong impact force is applied to the connector housings.

### BACKGROUND ART

Conventionally, as a means to mechanically assemble a plurality of printed boards and to electrically connect electronic portions mounted thereon, board connection apparatus are known that uses a removable pair of electric connectors attaching to the printed board to connect each other.

FIG. 7 shows a pair of electric connectors for connecting printed boards and printed board connecting apparatus described in Japanese Unexamined Utility Model Application Publication No. H6-44063 and more specifically it shows a cross sectional view of the pair of electric connectors attached to printed boards and coupled thereto.

The electric connector for connecting the printed board consists of a pair of electric connectors 1, 6 and both have a removable structure. The one electric connector 1 comprises a contact portion housing 2 holding a contact portion 4a of a contact terminal 4 and a tail portion housing 3 that is different from the contact portion housing holding a tail portion 4c of the contact terminal 4. The contact portion 4a of the contact terminal 4 is inserted into the contact portion housing 2 and the tail portion 4c of the contact terminal 4 is inserted into the tail portion housing 3 respectively. The flexible connection portion 4b connects the contact portion housing 2 and the tail portion housing 3. The contact terminal 4 consists of two portions of which lead position is different and a plurality of leads is arranged so that the tail portion 4d, 4d′ are attached to both housing 2,3 and are derived in zigzag pattern.

The other electric connector 6 comprises a housing 7 holding a contact terminal and a contact terminal 8 mounted therein. A pair of electric connector 1 and 6 are respectively attached to the printed board 5 and 9. As can be seen from the example showing the connection of the electric connector 1 and the printed board 5 in FIG. 7, the tail portion 4d, 4d′ are inserted into each holes of the printed board 5 and are soldered to form copper foil patterns by soldering 5a, 5a′ at the back side of the printed board, and the other electric connector 6 is fixed to the printed board 9 by the soldering etc.

According to this configuration, even if the position of the other printed board 9 against the printed board 5 displaces from the predetermined position because of errors that may be caused when the electric connector is attached to the printed board, or errors in designing the portions, both electric connectors can be connected with each other without difficulty. This is because the contact portion housing 2 and the tail portion housing 3 are separately formed and both are connected by the flexible connector portion 4b wherein the pitch displacement can be absorbed by the bent deformation of the flexible connector portion 4b. It also has further advantages that the displacement load is small because the pitch displacement can be absorbed only by the deformation of the flexible connector portion 4b.

This electric connector 1 can absorb the position displacement when both connectors are coupled. However, when some obstacle and the like strikes it from the perpendicular direction of the printed board 5, that is, from the immediately above the contact portion housing 2 and the strong impact force is applied, a crack is generated at the soldering portion 5a, 5a′.

That is, the impact force is transmitted from the contact portion housing 2 via the flexible connector 4b and the tail portion housing 3 to the soldering portion 5a, 5a′ which solders the terminal 4d, 4d′ to the copper foil pattern. Accordingly, the most strong impact force is transmitted to the soldering portion 5a, 5a′ because the soldering portion 5a, 5a′ is mechanically the most weak portion and because this portion is subject to the strong impact force. This impact force generates a crack in the soldering portion, thus causing an electrical contact failure.

It is widely recognized in the various fields, that the impact force from the perpendicular direction to the printed board generates a soldering crack more frequently than that from the parallel direction to the printed board.

Also this impact force from the perpendicular direction deforms permanently the flexible connector 4b and it prevents from absorbing the above-described displacement. This made the connection to the other contact terminal unstable to have caused an electrical contact failure.

The present invention was made to overcome this problem of the conventional technology and the object of the present invention is to provide a connector for connecting printed boards that can movably locate and fix a pair of connector housings and that can be attached to printed boards firmly.

Also, another object of the present invention is to provide a connector for connecting printed boards that absorbs the pitch displacement between itself and the other connector and that can absorb an impact force being applied to a connector housing coming from the perpendicular direction of the attachment board.

Further object of the present invention is to provide a connector for connecting printed boards that have stable contact reliability without affecting a contact portion with the other connector when the impact force is applied to a connector housing.

Further object of the present invention is to provide a connector for connecting printed boards that increase the packing density of the contact terminal to the connector housing.

Further object of the present invention is to provide a printed board connecting apparatus that prevents a generation of a crack at the connection soldering portion of the printed board and the connection portion of the contact terminal.

### DISCLOSURE OF THE INVENTION

The connector for connecting printed boards in the present invention comprises contact terminals wherein contact portions and board connection terminals are connected by the spring bodies; a movable housing for receiving the contact portions of the contact terminals; a fixing housing to which the board connection terminals of the contact terminals are fixed; wherein through-holes penetrating the both movable and fixing housings are provided, reinforcing pins are inserted into the through-holes to make the movable housing to move up and down in the predetermined range against the fixing housing, the contact terminals are attached both to the movable housing and the fixing housing, and both housings are separated in a predetermined distance and connected by the spring bodies.

The above-described spring bodies are formed by the flexible plate that can absorb an impact. Preferably, one or plural spring bodies, such as approximately lateral U-shaped spring bodies or leaf spring bodies are connected in series. Also preferably, the distance between the movable housing and the fixing housing is defined so as not to deform permanently the spring bodies when the spring bodies are deformed.

Also it is preferable that the through-holes are formed at the both ends of the movable housing and fixing housing and the length of the reinforcing pin is set so that the pin may project the predetermined distance from the upper and lower faces of the housing in which the movable housing and the fixing housing are separated by the predetermined spacing and stacked.

With this configuration, the reinforcing pin is inserted into the through-hole of the fixing housing to be fixed inside the through-hole, and also the reinforcing pin is inserted into the through-hole of the movable housing. Then the movable housing is aligned along the predetermined track by the reinforcing pin and is positioned precisely to the fixing housing. After that, the contact terminals are attached to the movable housing and fixing housing and both housings are connected with the predetermined spacing by the spring bodies.

Because the reinforcing pin regulates the moving direction of the movable housing, even when an impact arises from the right or left direction, the elastic tongue contacting with other contact points does not open and a stable and reliable contact is obtained.

Also even if an impact is applied from right above the movable housing, the movable housing moves downward by the impact force, and at the same time the impact force is also transmitted to the spring bodies of the contact terminals to bend the spring bodies and the impact force is absorbed by this bending. Accordingly, the impact force to the connection terminal is attenuated rapidly and when the connection terminal is soldered to the printed board, a large impact force is not transmitted to the soldering portion and thus it can prevent an occurrence of the crack at the soldering portion.

Also a damage to the spring bodies can be prevented because the spacing between the movable housing and the fixing housing is set so as not to deform permanently the spring bodies when the spring bodies are deformed, bent and absorbs the impact force. Also because the reinforcing pin is loosely fit inside the through-hole of the movable housing, even if a position displacement arises when connecting to other connectors (not shown), the position displacement can be absorbed.

Also by soldering the lower end of the reinforcing pin to the printed board, the connector and the printed board are coupled firmly. With the increase of the mechanical coupling force with the printed board, even if an impact force is applied from the horizontal direction, because the connector is firmly coupled to the printed board by the reinforcing pin, the reinforcing pin receives the force and the impact is not transmitted to the contact terminals. In addition, when connecting to other connectors, even if there is a position displacement between the connectors, because the movable housing moves up and down to absorb the position displacement automatically and a smooth connection between the connectors can be accomplished.

When the strong impact is applied to this spring bodies, the spring bodies made of flexible plates bends and absorbs the impact force. With one or a plurality of approximately lateral U-shaped spring bodies or leaf spring bodies connected serially, and selecting the quantity, it can correspond to the various impact forces depending on the usage environment of the connector.

The connector for connecting printed boards of the present invention is characterized in that the contact container portion of the movable housing is formed with a plurality of stages of the shelf, and that a plurality of contact portions is separately aligned to the each shelf, and that the board connection terminal is fixed to the fixing housing. And the lateral width of the spring bodies formed by thin plates and the board connection terminals of the contact terminals is preferably set as narrower than that of the contact portions. With this configuration, the contact portions of the contact terminals is contained in each open hole arranged in a plurality of stages and the connection terminals connected to the contact portions can be fixed by the fixing housing, thus increasing the packaging density of the contact terminals in the housing by arranging the plural stages of the open holes.

The apparatus for connecting printed boards of the present invention employs the above-described electric connector and is characterized in that board connection terminals of the electric connector is connected to the one end of the reinforcing pin by soldering. And it is preferable to use the other end of the reinforcing pin for positioning the connector to the housing of the electronic equipment. That is, the projected lower end of the reinforcing pin is fixed to the printed board and the upper end is used to align the connector to the packaging equipment according to the necessity. Then, the unit of printed board packaging the connector can be installed in the electronic equipment without a position displacement.

### BRIEF DESCRIPTION OF THE DRAWINGS

FIG. 1 shows a connector for connecting printed boards according to one embodiment of the present invention: FIG. 1(A) is an exterior perspective view from the front of the connector; and FIG. 1(B) is an exterior perspective view from the backside of the connector.

FIG. 2 shows a cross section of the connector of FIG. 1: FIG. 2(A) is a cross sectional view of the connector at A-A of FIG. 1; FIG. 2(B) is a cross sectional view of the connector at B-B of FIG. 1; and FIG. 2(C) is a cross sectional view of the connector at C-C of FIG. 1.

FIG. 3 shows a movable housing of the connector of FIG. 1: FIG. 3(A) is an external perspective view from front side; FIG. 3(B) is an external perspective view from the backside.

FIG. 4 shows a fixing housing of the connector of FIG. 1: FIG. 4(A) is an external perspective view of the connector from front side; and FIG. 4(B) is an external perspective view of the connector from backside.

FIG. 5 shows a contact terminal: FIG. 5(A) is a perspective view of the contact terminal to be attached to the lower portion of the movable housing; FIG. 5(B) is a perspective view of the contact terminal to be attached to the upper container portion.

FIG. 6 shows an external perspective view of the reinforcing pin of FIG. 1.

FIG. 7 shows an electric connector for connecting printed boards and an apparatus for connecting printed boards in the prior art and it is a cross sectional view showing a status in which a pair of electric connectors are attached and coupled to the printed boards respectively.

### BEST MODE FOR CARRYING OUT THE INVENTION

One embodiment for carrying out the invention will be explained hereinafter, based upon the figures.

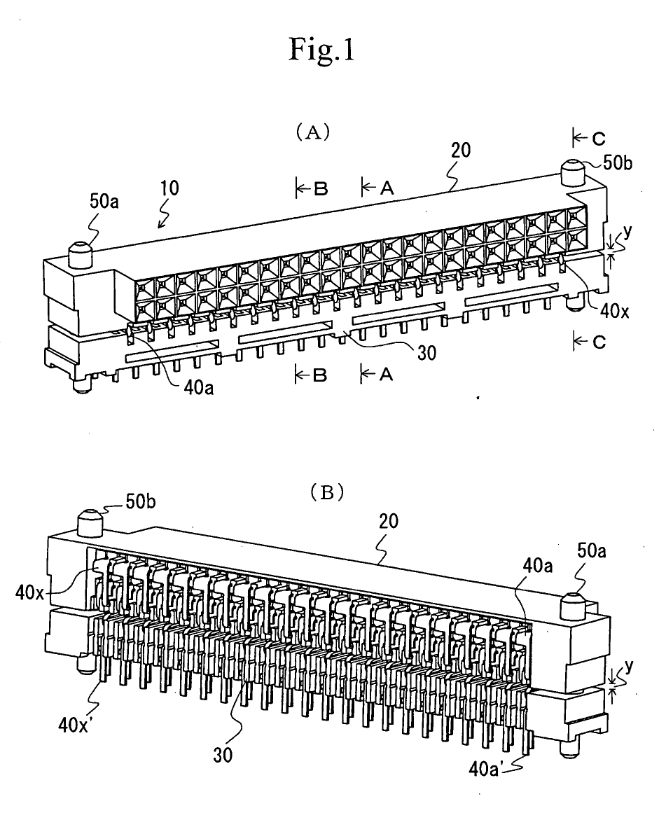

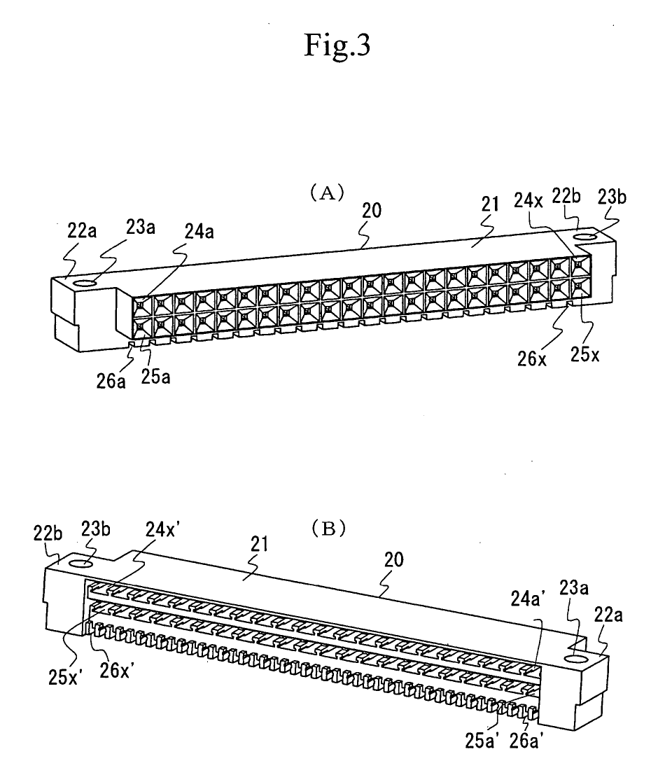

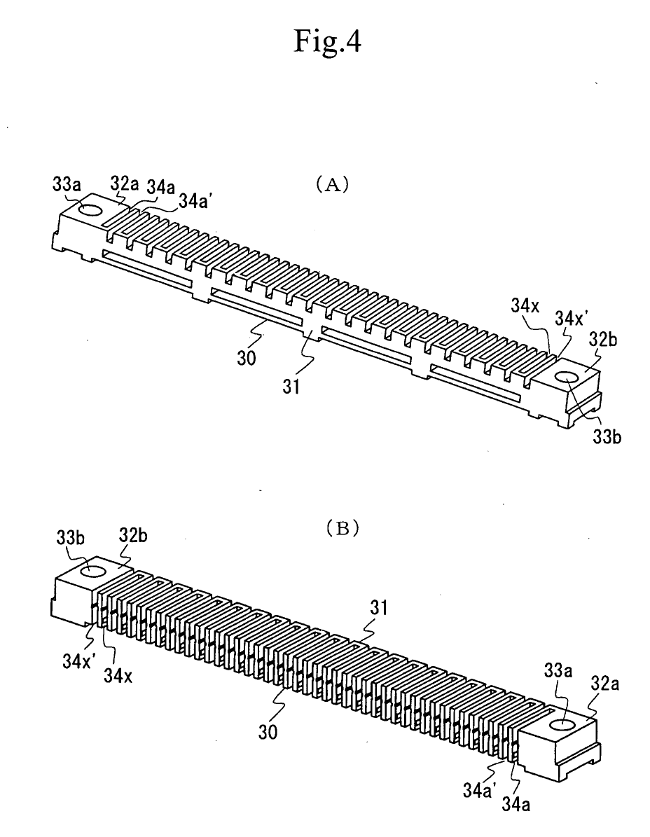

In the examples shown in FIGS. 1 to 4, a connector 10 for connecting printed boards comprises a pair of housings consisting of a movable housing 20 and a fixing housing 30; a pair of reinforcing pins 50a, 50b connecting both the housings; a plurality of electrical contact terminals 40a-40x, 40a′-40x′. Both the housings 20, 30 are molded by synthetic resin in approximately rectangular parallelepiped shape. Both the housings are integrally molded in which they are connected by connection members (not shown) in advance when molding, and after the molding the connection members are cut off, so that the movable housing 20 may be mounted on the fixing housing 30 with the predetermined spacing y when assembling. Of course both the housings can be separately molded.

At the both ends of the longitudinal axis direction of the movable housing 20, fixing bases 22a, 22b are formed and in each fixing base, through-holes 23a, 23b are provided. In these through-holes, reinforcing pins that will be explained later are inserted. The diameter of the hole is slightly larger than that of the outer diameter of the reinforcing pin so that at least the movable housing 20 can move up and down in a status in which the reinforcing pin is inserted into the through-hole.

The rectangular parallelepiped housing of the movable housing 20 between the fixing bases 22a, 22b of the both ends protrudes to the front direction and a container portion is formed inside the protruded portion to receive a plurality of the contact terminals. The container portion comprises upper and lower shelves to be attached to the contact portions of the contact terminals and a groove receiving the spring bodies of the contact terminals. This container comprises a plurality of pair of ribs 24a′-24x′, 25a′-25x′ formed by arranging separately a plurality of contact portions of the contact terminals at the upper wall surface of each shelf, at the back of the movable housing 20; and a plurality of grooves 26a-26x in which the spring bodies of the contact terminals are inserted to the bottom wall surface the movable housing 20.

And at the front of the movable housing, a plurality of apertures 24a-24x and 25a-25x are formed for which the contact terminals of the other connecter (not shown) are inserted and at the bottom surface, a plurality of grooves 26a-26x are formed for which the spring bodies of the contact terminals are inserted.

The fixing housing 30 comprises through-holes 33a, 33b to which reinforcing pins are penetrating are formed at the both fixed bases 32a, 32b and a plurality of grooves receiving contact portions of the contact terminals which are formed between the fixed bases. The through-holes are formed according to the outer diameter of the reinforcing pin that will be explained later and the shape can be the circle, ellipse, square or any other. The inner diameter of the through-hole is almost close to the outer diameter of the reinforcing pin and the dimensions are made so that the outer surface of the reinforcing pin may contact the inner surface of the through-hole when the reinforcing pin is inserted into the through-hole. The grooves are provided parallel to the direction that are perpendicular to the longitudinal axis direction of the fixing housing and a groove penetrating from the front to the back and a groove of which front is covered are arranged alternately.

The spring bodies of the contact terminals to be attached to the upper shelf are inserted in the grooves 34a-34x and the spring bodies to be attached to the lower shelf are inserted in the grooves 34a′-34x′. The container portions are formed with two shelves but the number of the stage is not limited and it can be formed by one stage, or three or more stages.

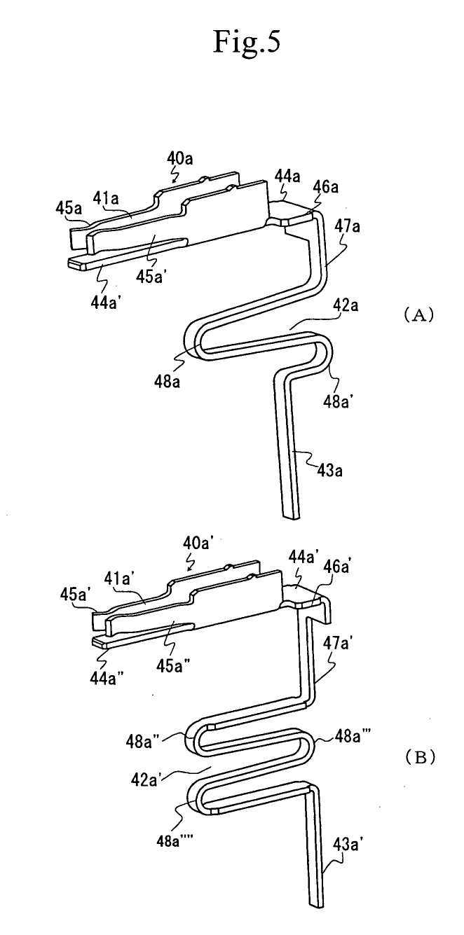

FIG. 5 shows contact terminals and FIG. 5(A) is a perspective view of the contact terminals that are attached to lower container of the movable housing and FIG. 5(B) is a perspective view of the contact terminals that are attached to upper container. Each of a plurality of terminals 40a-40x to be attached to lower container of the movable housing has the same shape. Therefore, the contact terminal 40a is explained as the representative.

The contact terminal comprises a contact portion 41a, a connection terminal 43a and a spring body 42a that connects them and is made of a conductive thin plate by punching works. The spring body 42a is made of a conductive thin plate, and has the flexibility and when the impact force is applied from right above the movable housing, it is bent and perform a function of absorbing the impact force.

The contact portion 41a is positioned at the end of the thin plate and comprises a flat tongue piece 44a′ and two elastic tongue pieces 45a, 45a′ that are bent almost perpendicularly from the two slits portion so as to come close to each other. As the two elastic tongue pieces are bent to the direction coming to close to each other, when the other contact portion (not shown) is inserted between these elastic tongue pieces, the good electrical contact is achieved by the elastic tongue pieces 45a, 45a′ and the flat tongue piece 44a′. The shape of the contact portion can be modified to any form adapting to the shape of the other contact portion. The shapes of these contact portions are well known and the explanation will be omitted.

The spring bodies 42a and the connection terminal 43a are formed by bending a strip 47a of which width is approximately half of that of the flat portion 44a and that is bent downward from the flat portion 44a. The strip 47a is formed by bending the flat portion 44a downward and cutting off the left half of the width as shown in FIG. 5(A). The spring bodies 42a comprises two serially connected two spring bodies 48a, 48a′ in which a plurality of spring bodies is serially connected and that are made by bending strip 47a downward to the direction parallel to the flat tongue piece 44a′ to form the lateral U shaped spring bodies. As the spring bodies 42a is formed by a plurality of lateral U shaped spring bodies 48a, 48a′, when the impact force is applied to the spring bodies 42a via the movable housing 20, the lateral U shaped spring bodies is crushed from upper side and absorbs this impact force. And when the impact force disappears, the spring bodies 42a returns to the original shape by own restoring force and separates the movable housing and the fixing housing with a predetermined spacing. A tongue piece 46a is the one portion of the tongue piece formed at both side of the flat portion 44a and is inserted into the open groove of the movable housing to perform a function of positioning the contact terminal.

The connection terminal 43a is bent downward from the middle portion of the spring bodies 48a′ and is inserted into the hole of the printed board (not shown) to be wired at the backside of the printed board and has enough length to allow to be soldered to the copper foil pattern.

A plurality of contact terminals 40a′-40x′ is the contact terminals that is contained in the upper container of the movable housing and have the same shape. Therefore a contact terminal 40a′ is explained as the representative. A contact terminal 40a′ has almost the same shape as that of the contact terminal 40a and only the different point is the configuration of a downward strip 47a′ and a spring bodies 42a′. Therefore the explanation of a contact portion 41a′ and a connection terminal portion 43a′ is omitted and only the difference points will be explained.

A downward strip 47a′ has roughly the half width of a flat portion 44a′ and has the shape of which right half is cut off as is shown in FIG. 5(B). When the contact terminal 40a and 40a′ are placed adjacently, as the strip 47a′ and above-described strip 47a are formed with the half width of the flat portion 44a′, 44a, the total width of both strip 47a′, 47a becomes almost the same as that of the thin plate and that of the contact portion 41a, 41a′. Thus when the contact portion 41a, 41a′ are placed in the open hole of upper and lower stage of the movable housing, each connection terminal is fixed in the fixing housing within the width of the contact portion. Therefore the contact terminal can be attached to the housing with high packaging density.

The spring body 42a′ has serially connected three spring bodies 48a″, 48a′″ and 48″″ in which a plurality of spring bodies are serially connected and that are made by bending strip 47a′ downward to the direction parallel to a flat tongue piece 44a″ to form the lateral U-shaped spring bodies. In this configuration, as the three spring bodies are serially connected, the impact force is more efficiently absorbed.

The connection terminal 43a′ is bent downward at the middle point of the spring body 48a″″. The length is almost the same but the downward position is different from that of the connection terminal and when a plurality of the contact terminals is attached to the housing, each connection terminal is arranged in zigzag pattern.

The shape of the spring bodies described here is almost U shaped but the shape is not limited and it can be any shape such as leaf shape etc. And the explanation of the shapes of the spring bodies will be omitted because any shapes of the spring bodies are well known. The contact portions of a plurality of contact terminals to be attached to the upper and lower container of the movable housing have same shape respectively, but the spring body and the connection terminal have the different shapes.

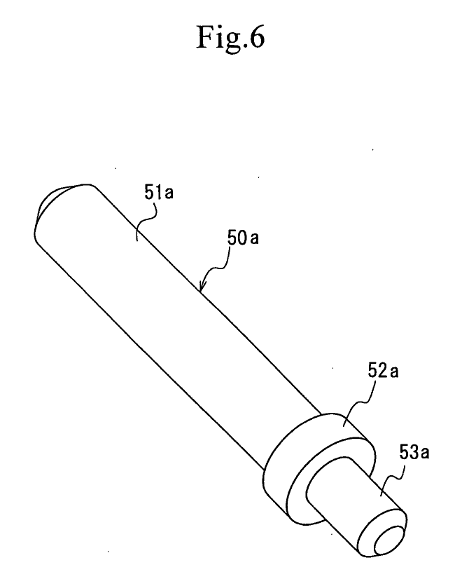

FIG. 6 is an external perspective view of the reinforcing pin. A pair of reinforcing pins 50a, 50b have the same shape as is shown in FIG. 1. Therefore one reinforcing pin 50a is explained as the representative. The reinforcing pin 50a is a bar of which shape is almost circular column and it is a flanged pin made of metal material. A flange portion 52a is formed with evagination at near the edge and with this flange as the boundary, a frontal portion 51a is long and a back end portion 53a is short. The diameter of the frontal portion 51a is slightly smaller than that of each though-hole 23a so that at least the movable housing 20 can move up and down when the reinforcing pin 50a is inserted into the through-hole 23a. The flange portion is not always necessary and the pin of the normal bar shape can be available. In this embodiment, the reinforcing pin 50a is formed to be a bar with a substantially circular column but the shape is an arbitrary element for the present invention.

The length of the frontal portion 51a is longer than the height of the stacked movable housing 20 and the fixing housing 30 when the frontal portion 51a is inserted into the through-hole 23a. And the frontal portion protrudes from the top surface of the movable housing and the length of the frontal portion is set to be long enough to perform a function of positioning the connector with relation to the housing of the equipment when the connector is installed in electronic equipments. The length of the back end portion 53a is set to be long enough to perform a function of positioning and fixing the connector when the back end portion is inserted into the hole (not shown) of the printed board. FIG. 1 shows that the frontal portion 51a and the back end portion 53a of the reinforcing pin are inserted into the through-holes 23a, 23b of the movable and the fixing housing 20, 30 and the tops of the pins protrude from the top surface and the bottom surface of the both housings.

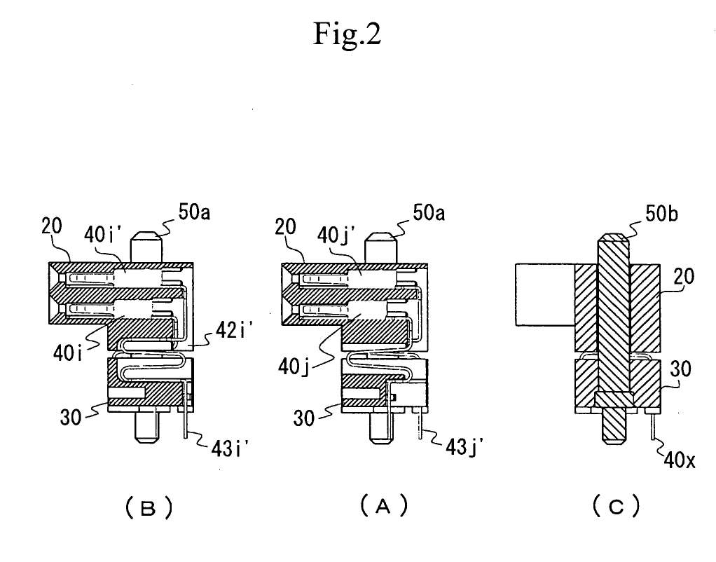

A method for assembling a connector will be explained hereinafter referring to FIG. 1 and FIG. 2.

The two reinforcing pins 50a, 50b are inserted into the through holes 33a, 33b of the fixing housing and the through-holes 23a, 23b of the movable housing respectively, the fixing housing is separated from the movable housing with a predetermined spacing, and the movable housing is movably stacked on the fixing housing. With this stack, grooves are formed at the facing surfaces stacking the movable housing and the fixing housing.

With this stacked status, a plurality of contact terminals 40a, 40a′ are prepared and from the back side of both housing, the contact portion is installed into upper and lower shelf of the movable housing, the lateral U-shaped spring bodies are installed in the grooves that are formed between both the housings, and the connection terminals are installed and fixed in the grooves of the fixing housings. With the attachment of each contact terminal, both the housings are connected by the spring bodies with a predetermined spacing y and the amount of this spacing is set so that the spring bodies are not deformed permanently when both the housings are contacted. And the connection terminal 43a, 43a′ is lead out of the bottom surface of the fixing housing alternately in zigzag pattern.

The assembled connector is attached to the printed board (not shown).

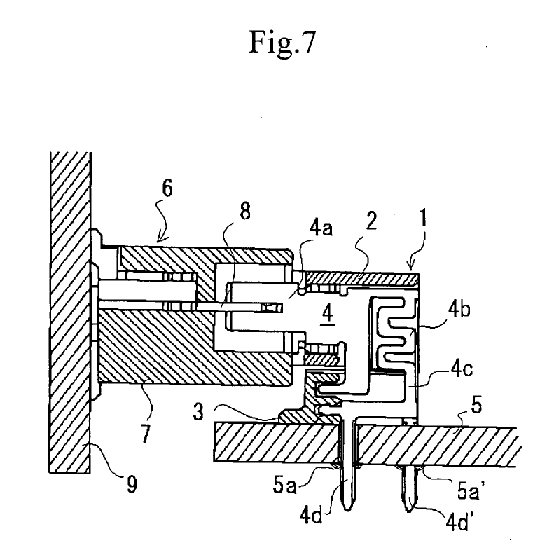

On printed boards, a plurality of the opened holes are provided as aligning the position of the reinforcing pin and each connection terminal in order to insert the lower end of the reinforcing pin and the connection terminal. The reinforcing pin and the connection terminal are inserted into these holes and are soldered to the printed board. The soldering connection technology of the printed board and the connection terminal is the same as the prior art shown in FIG. 7. And the top end of the reinforcing pin performs a function of positioning the connector with respect to the used equipment if necessary.

With this configuration, as the movable housing and the fixing housing are connected by the spring bodies with the predetermined spacing y and both ends of the fixing housing are fixed by the solid reinforcing pin, the position of the movable housing against the fixing housing is precisely determined and the path is modified even it is slightly displaced and the board unit packaging a connector can be positioned to the equipment by the reinforcing pin when it is attached.

Also even if there is a position displacement with other connectors (not shown), as the movable housing can move up and down against the fixing housing, the position displacement is easily absorbed. Also when some obstacle collide from right above the movable housing and apply the strong impact on the movable housing, the spring bodies of the contact terminal absorb the impact and the impact force is reduced so that an occurrence of the crack at the soldering portion can be avoided. Also the spacing y between the movable housing and the fixing housing is set so that the spring bodies are not deformed permanently when both the housings contact each other. Accordingly, even if the strong impact is applied to the spring bodies, the spring bodies are not deformed permanently.

1. A connector for connecting printed boards comprising:
a contact terminal wherein contact portions and board connection terminals are connected by spring bodies;
a movable housing for receiving the contact portions of the contact terminal;
a fixing housing to which the board connection terminals of the contact terminal are fixed;
wherein through-holes penetrating through both the movable housing and the fixing housing are provided, reinforcing pins are inserted into the through-holes so that the movable housing can move up and down within a predetermined range against the fixing housing, the contact terminals are installed in the movable and fixing housings, and both housing are connected by the spring bodies with a predetermined spacing.

2. The connector for connecting printed boards according to claim 1, wherein the inner diameter of said through-hole is almost close to the diameter of said reinforcing pin.

3. The connector for connecting printed boards according to claim 1, wherein said spring bodies are formed by flexible plates that can absorb an impact force.

4. The connector for connecting printed boards according to claim 1, wherein said spring bodies are formed by one or a plurality of approximately lateral U-shaped spring bodies or leaf spring bodies connected in series.

5. The connector for connecting printed boards according to claim 1, wherein said spacing between the movable housing and the fixing housing is set so that said spring bodies are not deformed permanently when they are bent.

6. The connector for connecting printed boards according to claim 1, wherein the length of the reinforcing pin is set so that the pin may project over a predetermined distance from the upper and lower faces of the movable housing and the fixing housing in which the housings are separated by a predetermined spacing and stacked.

7. The connector for connecting printed boards according to claim 1, wherein said movable housing comprises contact container portions formed of a plurality of shelves, the plurality of the contact portions are arranged separately in each shelves, and wherein board connection terminals are fixed in said fixing housing.

8. The connector for connecting printed boards according to claim 7, wherein said contact portions are formed by thin plates and the lateral widths of the spring bodies and board connection terminals are narrower than those of said contact portions.

9. An apparatus for connecting printed boards wherein said board connection terminal and one end of said reinforcing pin are connected to a copper foil pattern on a printed board by soldering with a connector according to claim 1.

10. The apparatus for connecting printed boards according to claim 9, wherein the other end of said reinforcing pin is used for positioning to an electronic equipment housing.
